(19) United States
(12) Patent Application Publication
(10) Pub. No.: US 2004/0185163 A1
(43) Pub. Date: Sep. 23, 2004

(54) Food provided for emergencies

(76) Inventor: Terumi Takaoka, Ehime-ken (JP)

Correspondence Address: MOONRAY KOJIMA, BOX 627, WILLIAMSTOWN, MA, 01267, US

(21) Appl. No.: 10/430,838

(22) Filed: May 6, 2003

(30) Foreign Application Priority Data
Mar. 17, 2003 (JP) 2003/71718

(51) Int. Cl. A23L 1/168

(52) U.S. Cl. 426/618

(57) ABSTRACT

The present invention relates to the food for emergencies, suitable for eating in times of the natural disasters and accidents, wherein the germinating cereal to which a certain amount of the powders of the young rice leaves and/or the leaves of the coleseeds are added, will be baked into a given size and as the germinating cereal is sealed into the sealed container which does not pass any air or light, not only the nutritious values of the germinating cereal but also various nutritious values (for example, vitamin, mineral, fiber or food fiber) proper to the young rice leaves and coleseeds are added so that the germinating cereal will become effective as food for emergencies and degradation of food can be prevented as the sealed container does not pass any air or light.

### BACKGROUND OF THE INVENTION

1. Field of the Invention

This invention relates to food provided for emergencies like natural disasters or accidents in general.

2. Description of the Prior Art

Dried bread is generally known as food provided for emergencies. The dried bread has less water than the ordinary bread, using the wheat flour (especially of medium stickiness) as a material and it should be baked well, being suitable for preserving and taking out.

However, the dried bread contains a small portion of vitamin and mineral (four major elements of sodium, potassium, calcium and magnesium and essential small-quantity mineral such as iron, zinc, copper, iodo, chromium, cobalt and manganese in general) and fiber and food fiber.

On the other hand, the cereal cakes are known, being formed in a certain shape after heating and pressing the germinating cereals like germinating brown rice.

The said cereal cakes can be used for food provided for emergencies as the said germinating cereal is provided with phosphorus in its process of germination, wherein the phosphoenzyme works and phytic acid will be dissolved into phosphoric acid and inositol and wherein the protein will be combined with amino acid, the fat will be combined with essential fatty acid and starch with sugar and mineral with amino acid so that the said germinating cereal will be easily absorbed into the body whereas minerals like zinc and vitamin will increase by several times and especially when the starch changes into sugar, there will be no need to add sugar separately and as such germinating cereal is baked into a determined shape, the natural-sweet cereal cakes can be obtained, wherein nutrition contained in the cereals can be easily absorbed into the body.

However, the fiber or food fiber is contained in such a small portion in the said cereal cakes that there is a problem that they cannot be absorbed sufficiently in respect of nutritive values when being used for emergency food to be provided for natural disasters or accidents, in which there is an extreme food shortage.

### SUMMARY OF THE INVENTION

The present invention consists in providing effective food for emergencies, which is able to prevent food from deteriorating as the sealed container does not pass air or light, being suitable for long-time preservation, wherein the germinating cereal is baked into a determined size upon adding a certain amount of powders of young rice leaves and/or powders of leaves of coleseeds, while adding various nutritive values (vitamin, mineral, fibers and food-fibers) of the plants of the young rice leaves and coleseeds to the nutritious values of the germinating cereal.

Another object of the present invention is to provide food for emergencies effective for eating in times of natural disasters or accidents in which a person is susceptible to excessive stress wherein the germinating cereal is set to be germinating brown rice, with anti-stress effects of the functional elements of orizanol contained in the germinating brown rice.

Furthermore, another object of the present invention is to provide food for emergencies for eating in times of natural disasters or accidents, wherein coleseeds are set to be kale, which kale has effects of anti-depression.

Furthermore, another object of the present invention is to provide food for emergencies capable of preserving the food tightly sealed inside for a long period of time under room temperature and rigid enough against outer pressure, wherein the sealed container is set to be a metal can container for any food.

Furthermore, another object of the present invention is to provide food for emergencies, which fits in any container like cans, wherein the germinating cereal will be baked to make so small a piece as to be eaten at once.

Furthermore, another object of the present invention is to provide an effective food for emergencies after the gamma-aminobutyric acid and/or essential amino acid contained in the powders have been enriched by far infrared radiation, wherein gamma aminobutyric acid (so called GABA) has been enriched, in such a way that inhibiting effects for elevated blood pressures, tranquilizing effects, improving effects for renal functions, improving effects for liver function, inhibiting effects for obesity and effects for removing odor in the mouth or body odor and, above all, tranquilizing effects. Furthermore, by enriching the essential amino acid, it is possible to absorb the amino acid which could not have been composed biologically inside the human body and by enriching the essential amino acid (tasty elements), it is possible to provide food for emergencies for improving the taste of the cereal food.

Furthermore, other objects of the present invention will be readily clarified in the below examples.

### BRIEF DESCRIPTION OF THE DRAWING

FIG. 1. Step-chart showing the manufacturing step of the minuscule powders to be added to the germinating cereals

FIG. 2. Property figure showing the contrast of the entire volume of the essential amino acid.

FIG. 3. Property figure showing other examples of the manufacturing process concerning the minuscule powders.

FIG. 4. Step-chart showing the manufacturing method of food provided for emergencies.

FIG. 5. Explanatory drawing of the germinating cereal having been baked

FIG. 6. Sectional view, showing the food for emergencies being sealed.

FIG. 7. Sectional view, showing other examples of the food provided for emergencies.

FIG. 8. Sectional view, showing other more examples of the food provided for emergencies.

### DESCRIPTION OF THE PREFERRED EMBODIMENTS

One example of the present invention will be specifically explained using the drawings below.

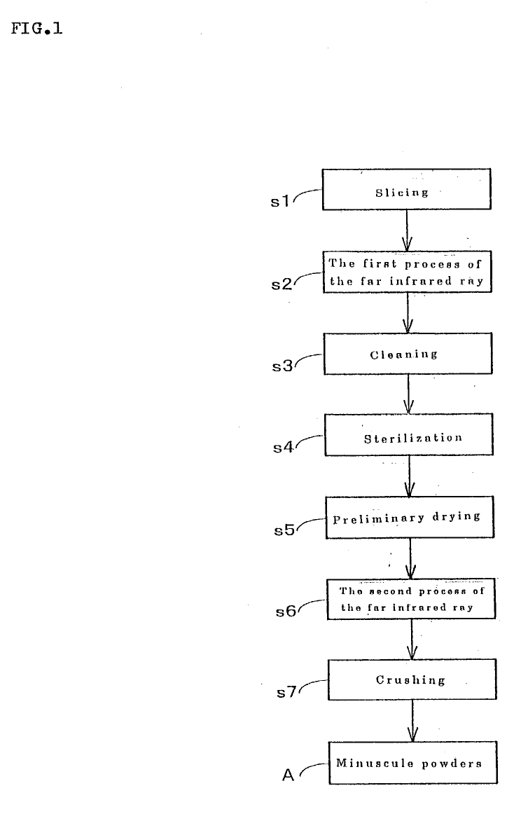

The figures show the food provided for emergencies and its manufacturing method and first of all, the process of the minuscule powders (powders of young rice leaves and minuscule kale powders) being formed will be explained with reference to the FIG. 1.

According to the FIG. 1, the young rice leaves as young leaves of the rice place plant or the kale leaves as the leaves of coleseeds will be prepared. Young rice leaves or kale leaves may preferably be cultivated without using any agricultural chemicals or fertilizers.

As for young rice leaves, they may have been cut out when they are young leaves before they come into ears and while the rice plant has grown as high as approximately from 20 to 50 cm. In the step-chart shown in the FIG. 1, the same process will be taken when the young rice leaves are used and the kale leaves are used.

Young rice leaves or kale leaves will be sliced in the slicing step s1 to make a piece of the leave of approximately 0.5 to 10cm.

In the next step of s2, which consists in enriching (or enriching step of GABA or essential amino acid) by the first process of the far infrared rays, the said far infrared rays will be irradiated within a short given period of time for about 30 seconds to 2.5 minutes toward the pieces of the leaves which have been cut out into a determined size. When the far infrared rays irradiates more than 2.5 minutes, the composed volume of the essential amino acid will decrease.

When the far infrared rays are irradiated as widely as possible on the pieces of the leaves, the glutamic acid contained in the pieces of the leaves will turn into gamma-aminobutyric acid (or so called GABA) and thus, the said gamma-aminobutyric acid will be enriched and multiplied and increased while the essential amino acid will be more actively composed by the far infrared irradiation.

In the next step of washing s3, the pieces of the leaves already enriched will be washed by using water or solvents (with the citric acid being added to water as a sterilizer).

In the next step of sterilization s4, the pieces of the leaves will be sterilized upon being washed. This sterilizing step will be carried out by dipping the leaves into the sterilizing water with the appropriate density of soda hypochlorite. The citric acid, intense bleaching powders are combined besides the steaming water to make medicines for composing the weak acid functional water and after the pieces of the leaves are dipped into the sterilizing water for a given period of time, they will be washed.

In the preliminary washing step c5, the pieces of the leaves will be put into the preliminary drying room after they are sterilized so that they are dried in the preliminary step and the remaining water will become 5-8wt %.

In the next step of far infrared rays s6, the pieces of the leaves are put into the drying room using the far infrared rays after they are dried in the preliminary stage so that they are irradiated by the far infrared rays and the water will be removed by the drying step therefrom, wherein the remaining water will become 2-3wt %.

By a reciprocal effect of the first step of the irradiation of the far infrared along the enriching step s2 and the second step of the irradiation of the far infrared of the step s6, the gamma-aminobutyric acid which stays green, will be contained further more.

In the pulverizing step 7, the pieces of the young rice leaves or kale leaves are pulverized into smaller pieces to become less than 100 μm, or preferably 0.5-80 μm in respect of the diameter in order to obtain minuscule powders A.

As the pulverizing device, the pulverizing measure like a mill can be used. When the diameter of the pieces of the leaves are less than 100 μm in, it is convenient as they will not be stuck in the throat.

The result of the measurement (the volume of the GABA contained) using the automatic analyzer of the amino acid in respect of the minuscule powders of the young rice leaves produced according to the manufacturing method as shown in the FIG. 1, will be shown in the [table 11]. The time indicated in the said table shows the time of irradiation by the far infrared rays.

TABLE 1

| Time | GABA (mg/100 g) |
|---|---|
| Before the processing | 19 |
| 0.5 minutes | 59 |
| 1.0 minutes | 50 |
| 2.5 minutes | 46 |

According to the table 1, it is clear that the GABA contained in the young rice leaves has increased by the process of the far infrared rays and the GABA contained has increased for 30 seconds of irradiation.

In the same manner, the result of the measurement of the GABA contained measured by the amino acid analyzer in respect of the minuscule powders of the kale leaves produced by the manufacturing method shown in the FIG. 1 is shown in the next table 2. The time specified is the same as in the table 1.

TABLE 2

| Time | GABA (mg/100 g) |
|---|---|
| Before the processing | 200 |
| 0.5 minutes | 580 |
| 1.0 minutes | 560 |
| 2.5 minutes | 530 |

According to the table 2, it is clear that the GABA contained in the young rice leaves has increased by the process of the far infrared rays and the GABA contained has increased for 30 seconds of irradiation.

In this way, according to the above method, the GABA contained in the young rice leaves is 46-59mg/100 g and that contained in the kale leaves is 530-580mg/100 g and both of the leaves will become more of green. Furthermore, in the above method, the protein, lipid, saccharides. Fiber, food fiber, calcium, phosphorus, iron, magnesium, zinc, general carotene, thiamin (vitamin B1), riboflavin (vitamin B2), general ascorbic acid (vitamin C), general tocopherol (vitamin E), methylmethionine sulfonium salt (vitamin U), superoxide eliminating active elements and general chlorophyl and other elements prove to be maintained as they are.

On the other hand, the result of the measurement of the volume of the essential amino acid measured by the analyzer of the biological liquid in respect of the young rice leaves produced by the manufacturing method shown in the FIG. 1, will be shown in the next table 3. According to the item of the example 1, the time of irradiation by the far infrared rays in the step s2 is set for 30 seconds and according to the item of the example 2, the time of irradiation by the far infrared rays lasts for 40 seconds and according to the item of the example 3, it lasts for 2.5 minutes, wherein according to the specific item, there is no irradiation of the far infrared rays.

TABLE 3
The following figures show the volume of the essential
amino acid contained in the young rice leaves (mg/100 g).

| | Thr | Val | Met | Ile | Leu |
|---|---|---|---|---|---|
| Ex. 1 | 104.4 | 193.1 | 45.7 | 82.2 | 121.5 |
| Ex. 2 | 93.9 | 195.9 | 52.2 | 69.2 | 104.2 |
| Ex. 3 | 64.2 | 131.6 | 54.7 | 39.7 | 70.0 |
| Spec. | 42.7 | 102.5 | 38.9 | 34.4 | 47.3 |
| | Phe | His | Lys | Trp | Total |
| Ex. 1 | 99.7 | 37.9 | 77.0 | 0.0 | 761.5 |
| Ex. 2 | 72.7 | 30.4 | 69.6 | 0.0 | 688.6 |
| Ex. 3 | 46.6 | 17.4 | 42.3 | 0.0 | 466.5 |
| Spec. | 44.9 | 15.7 | 40.6 | 0.0 | 367.0 |

The above-specified “Thr” means threonine, “Val” means valine, “Met” means Methionine, “Ile” means isoleucine, “Leu” means leucine, “Phe” means phenylalanine, “His”means histidine, “Lys” means lysine and “Trp” is the abbreviation of tryptophan, wherein 8 types of them except “His” are the essential amino acid. “His” is something composed inside the human body, however it is an indispensable amino acid for the childhood in which boys and girls grow rapidly.

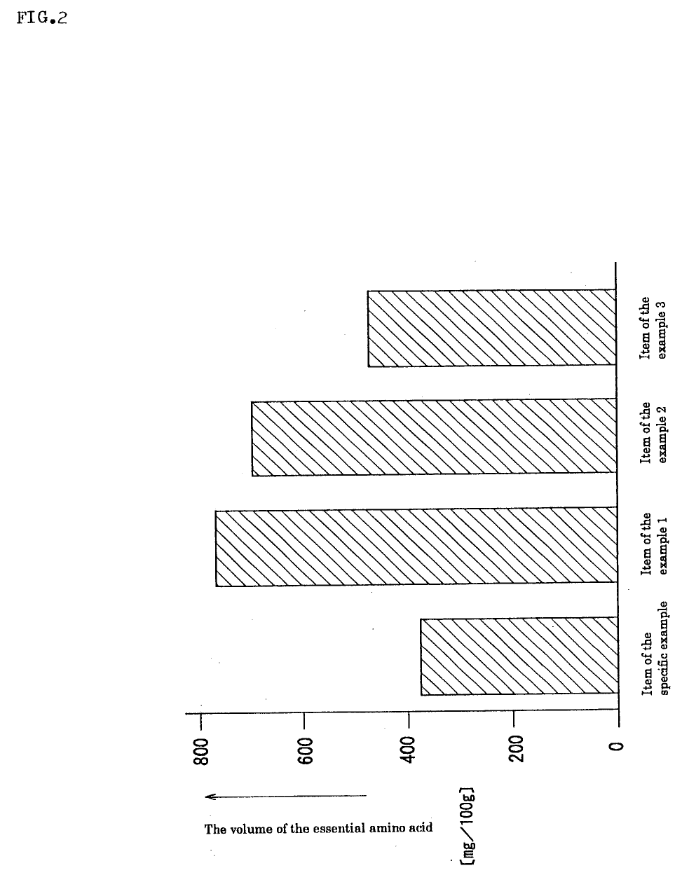

The FIG. 2 graphically shows the total amount of the essential amino acid of the above table 3 and it turns out that the essential amino acid of the items of the examples 1-3 and the total amount of them both increased greatly in comparison with the specific item where there is no irradiation of the far infrared rays. It should be noted that when the irradiation of the far infrared rays has lasted for 30 seconds, the essential amino acid has increased the most.

Furthermore, the young rice leaves contain the high nutritious values of protein, lipid, saccharides, fiber, food fiber, ash content, sodium, calcium, phosphorus, iron, potassium, magnesium, zinc, general carotene, vitamin A, β-carotene, vitamin B1, vitamin B2, vitamin C, vitamin U, superoxide eliminating active element, general chlorophyl and other elements and wherein the kale leaves have the high nutritious values of protein, lipid, saccharides, fiber, food fiber, ash content, sodium, calcium, phosphorus, iron, potassium, magnesium, zinc, general carotene, vitamin A, β-carotene, vitamin B 1, vitamin B2, general vitamin C, vitamin E, folic acid, vitamin U, superoxide eliminating active element and other elements.

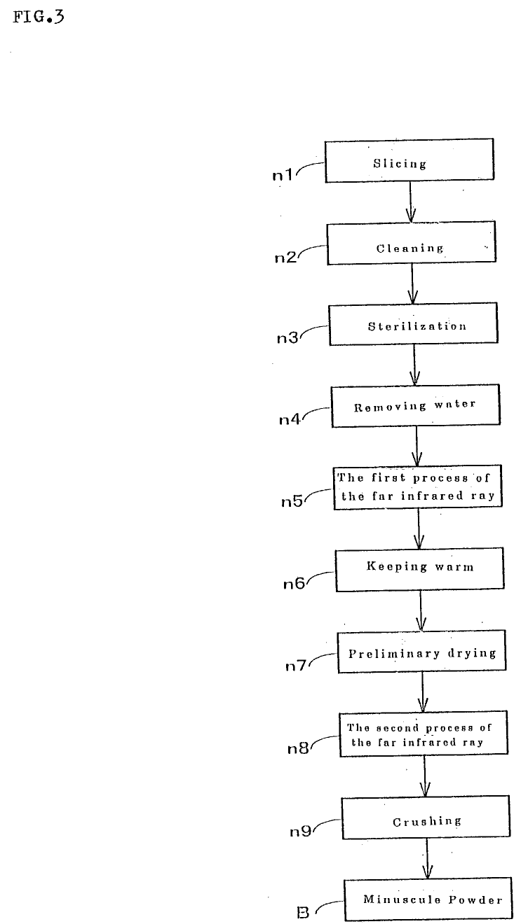

According to the FIG. 3, there is shown another step forming the minuscule powders and in the FIG. 3, young rice leaves are prepared as young leaves of the rice plants and kale leaves are also prepared as leaves of the coleseeds. In these stages, young rice leaves and kale leaves should be cultivated without using any agricultural chemicals or fertilizers.

As for young rice leaves, they should be cut out when they are in ears while being as high as approximately 20-50cm and as for kale leaves, the whole part of the kale leaves should be used. As for the chart-step shown in the FIG. 3, the steps are the same whether using young rice leaves or using kale leaves.

In the slicing step n1, young rice leaves or kale leaves should be sliced into pieces of approximately 0.5-10cm upon being cut out.

In the cleaning step n2, the pieces of the leaves are to be cleaned using water or solvents (wherein citric acid has been added to water as a sterilizer) upon being cut out into a given size.

In the sterilizing step n3, the pieces of the leave should be sterilized upon cleaning. In this sterilizing step, the leaves should be dipped into the sterilizing water with an appropriate density, mixed with soda hypochlorite. As for pharmaceutical agents, citric acid or appropriate agents for composing weak acid functional water comprising high-class bleaching powders are to be used besides steam, wherein the leaves are to be cleaned in water after dipping them into a sterilizing water for a given period of time.

In the dehydrating step n4, the pieces of the leaves will be dehydrated by a dehydrating device after sterilization.

In the enriching step n5 by the first process of the far infrared rays, the pieces of the leaves will be irradiated within a matter of approximately 30 seconds to 2.5 minutes by the far infrared rays upon dehydrating them. When the time of irradiation by the far infrared rays passes 2.5 minutes, the volume of composition of the essential amino acid will decrease.

When the pieces of the leaves are irradiated by the far infrared rays as evenly as possible, the glutamic acid contained in the pieces of the leaves will turn into a γ-aminobutyric acid (or so called GABA) so that the said γ-aminobutyric acid will be enriched, multiplied and increased and the essential amino acid will be more promptly activated by irradiation of the far infrared rays.

In the warming step n6, the pieces of the leaves are to be warmed for about 30 minutes to 1.5 hour by the warm wind of approximately 40 ° C. upon going through the first process of the far infrared rays.

In the next preliminary drying step n7, the pieces of the leaves are put into the preliminary drying room upon warming so that they are dried in the preliminary step and the remaining water will get 5-8 wt %.

In the step n8 of the second process of the far infrared rays, the pieces of the leaves are put into the drying room using the far infrared rays upon drying in the preliminary step and the far infrared rays are irradiated and water is removed by the drying step so that the remaining water will get 2-3 wt %.

The first process of irradiation of the far infrared rays in the enriching step n5 and the second process of irradiation of the far infrared rays in the step n8 are combined to give reciprocally elevating effects in order that more of the γ-aminobutyric acid for keeping green should be contained.

In the next pulverizing step n9, the pieces of the young rice leaves are pulverized into very small pieces to get the diameter of less than 100 μm or preferably 0.5-80 μm in order to get the minuscule powders B. As a pulverizing device, the pulverizing means like a mill can be used.

The result of the measurement (the GABA contained) of the minuscule powders of the young rice leaves produced by the manufacturing method shown in the FIG. 3, measured by the amino acid automatic analyzer, is shown in the next [table 4]. It is noted that the time of the said table indicates the time of irradiation of the far infrared rays in the step 5.

TABLE 4

| Time | GABA (mg/100 g) |
|---|---|
| Before the processing | 20 |
| 0.5 minutes | 62 |
| 1.0 minutes | 56 |
| 2.3 minutes | 50 |

According to the [table 4], it is evident that the GABA contained increased among the young rice leaves through the far infrared rays and after 30 seconds of irradiation, GABA contained increased the most.

In the same manner, the result of the measurement (the GABA contained) of the minuscule powders of the kale leaves produced by the manufacturing method shown in the FIG. 3, measured by the amino acid automatic analyzer, is shown in the next [table 5]. The time of the table indicates the same meaning as in the table 4.

TABLE 5

| Time | GABA (mg/100 g) |
|---|---|
| Before the processing | 200 |
| 0.5 minutes | 600 |
| 1.0 minutes | 580 |
| 2.5 minutes | 550 |

According to the table 5, it is evident that the GABA contained in the kale leaves increased through the process of the far infrared rays and after 30 seconds of irradiation the GABA contained has increased the most.

Thus, according to the above method, the GABA contained is 50-62mg/100 g in case of the young rice leaves and that of the kale leaves has reached to 550-600 mg/ 100 g and in either of the cases, the green has much more deepened and it has been clear that the protein, lipid, saccharides, fiber, food fiber, calcium, phosphorus, iron, magnesium, zinc, general carotene, thiamin (vitamin B1), riboflavin (vitamin B2), general ascorbic acid (vitamin C), general tocopherol (vitamin E), methylmethionine sulfonium salt (vitamin U), superoxide eliminating active elements, general chlorophyl and other elements have all been kept as they are.

On the other hand, regarding the volume of the essential amino acid, it is assumed that the minuscule powders A and minuscule powders B both increase in the same manner.

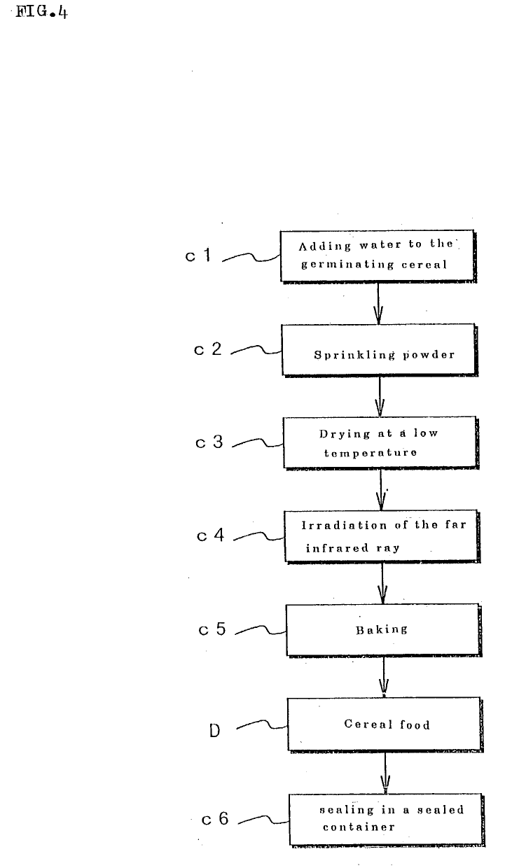

The FIG. 4 shows the manufacturing method of the food provided for emergencies (cereal food) and according to this example, as one example of the germinating cereal, the germinating brown rice is used.

In the step cl of the adding water, the water is sprayed toward lots of germinating brown rice. In this case, water should be sprayed so that the volume of the water to be added should reach around 1.0 wt %. When the water is sprayed (by a spraying device), water can be added so easily and evenly onto the whole part of the germinating brown rice and in the next step c2 of attaching the powders, the powders can be sprinkled in a very good condition.

In the step c2 of attaching powders, the minuscule powders A produced according to the manufacturing method of the FIG. 1 and the minuscule powders B produced according to the manufacturing method of the FIG. 3, which are young rice leaves and/or minuscule kale powders will be sprinkled toward the germinating brown rice after water has been added thereto.

In this stage, the volume of the minuscule powders of the young rice leaves may preferably be 0.5-2.5 wt % and the volume of the minuscule powders of the kale may preferably be 0.2-1.0 wt %. In other words, when the volumes are less than these minimums, young rice leaves and kale will have too poor nutritious values to add and when the volumes exceed the higher limit, they will be costly and in addition to that, the cereal food will get less tasty, so the above volumes of the minuscule powders of the young rice leaves and the kale should preferably be within that given scope. On the other hand, regarding the minuscule powders of the young rice leaves and the kale, the attaching step c2 is carried out after the step c 1 of adding water so that the minuscule powders A and B will be attached evenly and surely onto the germinating cereal.

In the next step c 3 of drying at a low temperature, the germinating brown rice will be dried at a low temperature around 30 ° C upon being sprinkled with the minuscule powders A and B. In the next step c 4 of the irradiation by the far infrared rays, the germinating brown rice will be irradiated evenly by the far infrared rays upon drying at a low temperature so that the very inner part will be surely dried, while taking out the best condition of the nutrition contained in the germinating brown through the far infrared rays in such a manner that they will be processed to be easily absorbed into the human body.

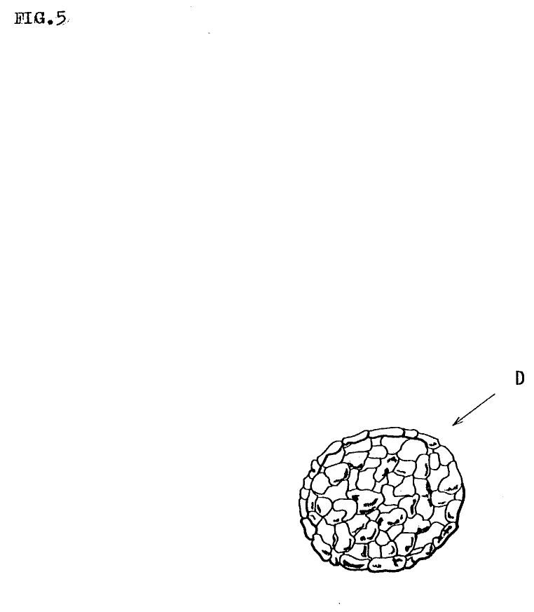

In the next step c 5 of baking, the germinating brown rice will be put into a baking mold after finishing each of the steps c 1 -c 4 and the germinating brown rice will be baked at a temperature around 200 to 280° C., more preferably 240° C. for the heating time of 2-10 seconds while applying the pressure of 6 Kg/cm² approximately. Then, the water will be removed from the germinating brown rice to swell and become the cereal food D (See the FIG. 5.) to be eaten at once (with one bite), of the thickness of approximately 1-2mm, the diameter of approximately 2.5-4.0cm or preferably about 3 cm. Thus, the germinating brown rice will be baked into a cereal food D, which is crispy and quite tasty and when putting hot water, it will become rice soup and can be eaten as such. It should be noted that each of the specific figures is only an example and the scope of the invention should not be limited to that.

Alternatively, black beans (including the germinating black beans) can be added after they have been crushed into the same size as the said brown rice, besides black sesames, hijiki (Japanese seaweed), laver (so called aonori or green laver) and small fishes and other additive food or a suitable volume of salt or soy sauce, condiments or spices.

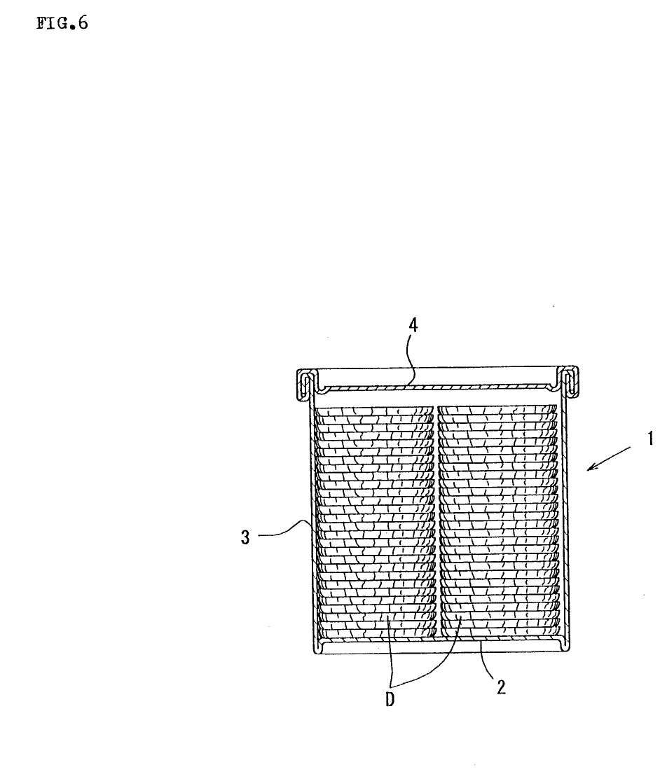

In the next step c 6 of closing, a lot of the cereal food D already baked will be put into a metal can container 1 for food wherein air or light does not pass as shown in the FIG. 6 as being a closed container which is air-sealed and water-sealed so that the food will become suitable for emergencies as they are canned.

According to the example of the FIG. 6, there is provided the bottom part 2 as a metal can container 1 and the tube part 3 and the lid part 4 as the side wall and there is shown a can wherein the peripheral edge of the lid part 4 with a sealing compound applied is closed on the upper side of the tube 3 by a double enrolling device and also an easy open can may be used.

The cereal food D may be contained inside the a metal can container 1 not only being aligned as shown in the figure but also being comprised in an arbitrary way.

The food provided for emergencies as in the above example is sealed into a sealing container (See the metal can container 1.) which does not pass the air or light, wherein the germinating cereal (See the germinating brown rice.) has been baked into a given size after they were given a certain amount of the minuscule powders of the young rice leaves and/or the minuscule powders of the leaves of coleseeds (See the kale.).

Being constructed as above, in addition to the nutritious values of the germinating cereal, various nutritious values (vitamin, mineral, fiber, food fiber and others) of the young rice leaves and coleseeds (See the “kale”.) may be added so that they will become very effective food for emergencies and the sealed container (See the “metal can container ”.) does not pass the air or light, it is possible to prevent degradation of the cereal food D sealed into the container 1 and thus they can be preserved for a long period of time.

Furthermore, when the said germinating cereal is set to be germinating brown rice, it has the functional elements of orizanol with the anti-stress effects and because there is a lot of stress suffered at the time of natural disaster or accidents, it can be eaten for the case of emergencies and has a lot of effects.

In addition, when the said coleseeds are set to be a kale, as it has anti-depression effects, it is effective as food provided for emergencies and as a kale is the most nutritious material, comparing with any other coleseeds, it is quite effective as a food for emergencies.

In addition, when the said sealed container is set to be a metal can container 1 for food, it is possible to preserve the cereal food D which has been sealed inside, for a long period of time under an ordinary temperature, while the rigidity against the outside force can be conserved.

Furthermore, when the said germinating cereal D is baked into such an appropriate size as to be eaten at once with only one bite, it is easy to eat and to be contained in the container 1 such as a can.

In addition, when the minuscule powders are set to be those enriched as regards γ-aminobutyric acid and/or the essential amino acid by irradiation of the far infrared rays, they have the following effects.

In other words, by the enrichment of γ-aminobutyric acid (or GABA), inhibitory effects for elevated blood pressure, tranquilizing effects, improving effects for the kidney function, and for liver function, effects preventing obesity and effects for removing odors of the mouth and the body can be obtained. Especially the said tranquilizing effects can be obtained so that they will be effective for food for emergencies. Also, by the enrichment of the essential amino, it will become possible to absorb the amino acid, which could not have been composed in the human body and by the enrichment of the essential amino acid (tasty elements), the cereal food D will get more tasty.

As shown in the above example (See the FIG. 4.), in the step c 2, when the germinating cereal and young rice leaves and/or the leaves of the coleseeds (See the kale.), thus making minuscule powders out of them or when only the young rice leaves and/or the leaves of coleseeds are put into minuscule powders, by the volume of the water contained in the germinating cereal (in case of the germinating brown rice, the water contained is approximately 14.5-17.5 wt %), evenly mixed condition of them can be obtained and management and abbreviation of the whole step can be carried out and also, the cereal food D can stay rather tasty.

Furthermore, when the minuscule powders are sprinkled on the germinating cereal, they will get inside the germinating cereal, so when they are baked, it is less possible that the minuscule powders might be baked directly in the baking mold and as a result it is possible to prevent as much as possible the dissolution of the mineral or vitamin and others contained in the minuscule powders by the heat.

As shown in the above example (See the FIG. 4.), when there is adopted a method of providing the step c 1 of adding water to the germinating cereal in the prior stage of the step c 2 of attaching the powders, the germinating cereal will be added water so that the minuscule powders will be quite easily sprinkled and even though the water has been added, the taste will not be affected in a bad manner because the water will be evaporated and removed by the time the germinating cereal is baked.

In addition, as shown in the above example (See the FIG. 4.), in the above-mentioned step c 1 of adding water, the water may be sprayed to the germinating cereal so that water will be easily and evenly showered on the whole part, making sure that the minuscule powders will be attached evenly.

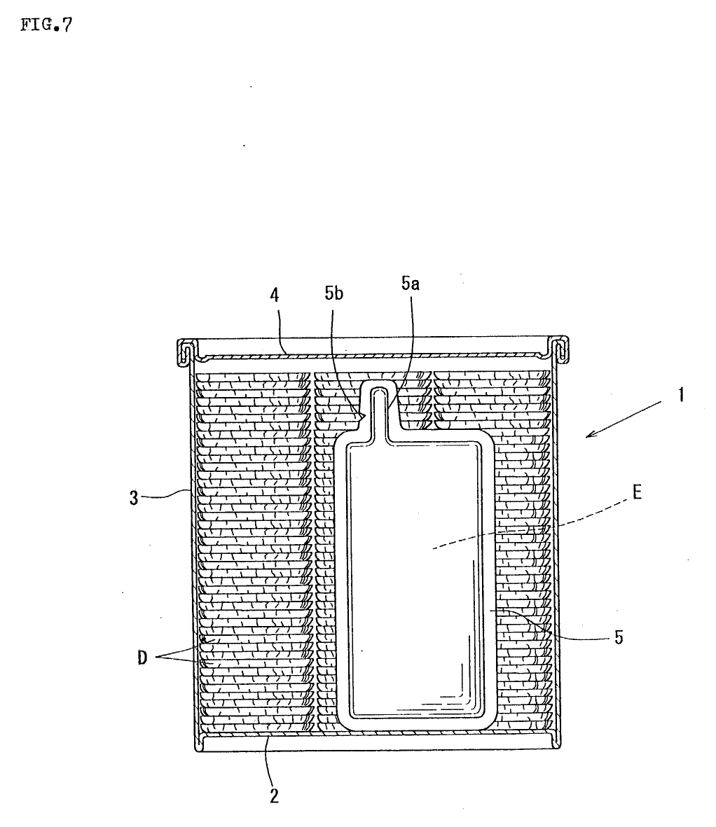

The FIG. 7 shows another example of the food for emergencies, wherein the drink E such as drinking water, mineral water and nutritious drink are water-sealed inside the container 5 made of the synthetic resin, for example of the polyethylene, together with the cereal food D in the metal can container 1, taking into consideration the fact that in times of natural disasters and accidents, not only food but also drink will lack.

Also, in the container E of the synthetic resin there is provided a drinking mouth 5 a protruding, wherein the cut-in part 5 b is provided in the container E for opening one part of the said drinking mouth 5a when drinking.

As being constructed thus, the cereal food D and drink E can be absorbed into the human body as food so that they will be very useful for food for emergencies.

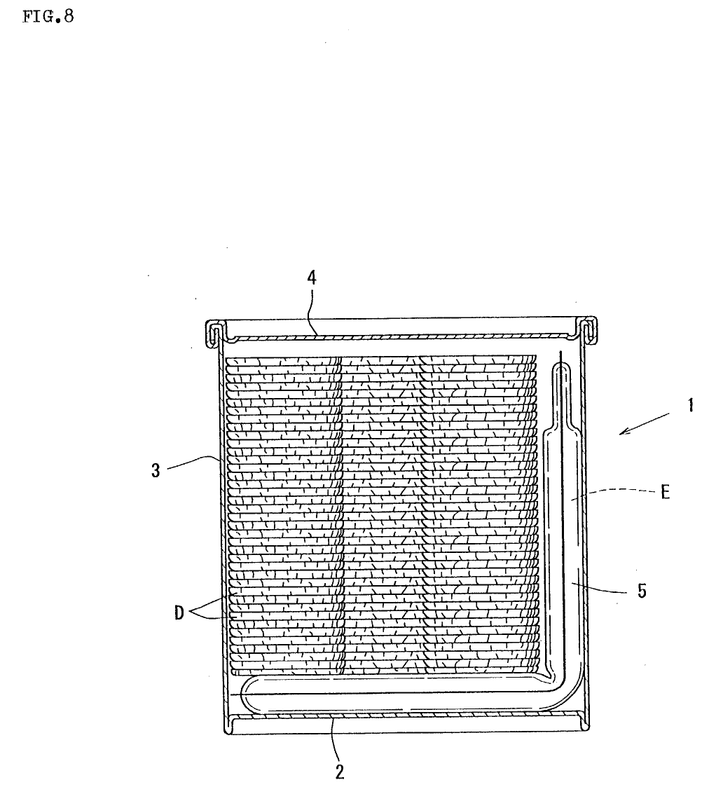

The FIG. 8 shows another example of the food provided for emergencies, wherein the drink E is water-sealed in the container of the synthetic resin and this is installed in the metal can container from the inner part of the bottom 2 to the inner part of the tube 3 in the shape of the letter L.

Being thus constructed, the drink E can increase its volume, which will be contained in the metal can container 1.

According to the examples shown in the FIGS. 8 and 9, other constructions, operations, and effects are the same as in the examples of the FIGS. 1-6, thus the same signs are put for the same part as in the previous figures and more detailed explanation will be omitted.

As for the construction of the present invention in relation with the above-mentioned examples, the powders of the present invention corresponds to the minuscule powders of the diameter less than 100 μm and thus, the coleseeds corresponds to the most nutritious kale, wherein the sealed container corresponds to the metal can container 1, however, the scope of the present invention will not be limited to the construction of the above-mentioned examples.

The germinating cereal may be rice, wheat, millet, barnyard millet or corns (so called “five grains”), independently, or any combination of them and to the germinating cereal to which the minuscule powders are added, other additive food, condiments or spices may be added in order to give other nutritious elements or flavor.

Furthermore, as coleseeds, turnip, cauliflower, “cresson”, Chinese cabbage, cabbage, radish, leaf mustard, “Wasabi”, broccoli and other coleseeds may be used.

1. Food provided for emergencies, wherein the germinating cereal to which a certain amount of the powders of the young rice leaves and/or the leaves of the coleseeds are added, will be baked into a given size, which germinating cereal is sealed into the sealing container which does not pass any air or light.

2. The food provided for emergencies according to the claim 1, wherein the said germinating cereal is set to be a germinating brown rice.

3. The food provided for emergencies according to the claim 1, wherein the said coleseeds are set to be kale.

4. The food provided for emergencies according to the claim 1, wherein the above-mentioned sealed container is set to be a metal can container for food.

5. The food provided for emergencies according to the claim 1, wherein the above-mentioned germinating cereal is baked into such a small size to be eaten at once.

6. The food provided for emergencies according to the claim 1, wherein the above-mentioned powders are set to be those enriched of the γ-aminobutyric acid and/or the essential amino acid, which have been irradiated by the far infrared ray.
